(19) United States
(12) Patent Application Publication
(10) Pub. No.: US 2025/0260110 A1
(43) Pub. Date: Aug. 14, 2025

(54) ENERGY ABSORBING COMPONENT FOR BATTERY ENCLOSURE

(71) Applicant: Rivian IP Holdings, LLC, Irvine, CA (US)

(72) Inventors: Efran Elias MARTINEZ, Whittier, CA (US); Piyush KHATER, Mission Viejo, CA (US); Bruce Philip EDWARDS, Menlo Park, CA (US); Sante Alexander DICECCO, Amherstburg (CA); Jonathan VERGHESE, Costa Mesa, CA (US); Daniel Kurt MEHR, Irvine, CA (US)

(21) Appl. No.: 18/441,925

(22) Filed: Feb. 14, 2024

(51) Int. Cl. H01M 50/242; H01M 50/249

(52) U.S. Cl. CPC H01M 50/242; H01M 50/249; H01M 2220/20

(57) ABSTRACT

Certain embodiments provide an energy absorbing component for a battery enclosure that includes collapsible ribs disposed between a first member and a second member of a battery enclosure. The collapsible ribs are configured to deform to absorb impact energy. Each collapsible rib includes a first portion joined to the first member, and a second portion joined to the second member. The first portion has a first thickness, and the second portion has a second thickness that is different than the first thickness.

### INTRODUCTION

The present disclosure relates to electric vehicles (EVs). More particularly, the present disclosure relates to battery enclosures for electric vehicles.

### SUMMARY

Embodiments of the present disclosure advantageously provide an apparatus, such as an energy absorbing component for a battery enclosure, that includes a collapsible structure disposed between an upper member and a lower member.

In certain embodiments, the energy absorbing component includes collapsible ribs disposed between a first member and a second member of a battery enclosure. The collapsible ribs are configured to deform to absorb impact energy. Each collapsible rib includes a first portion joined to the first member, and a second portion joined to the second member. The first portion has a first thickness, and the second portion has a second thickness that is different than the first thickness.

In other certain embodiments, an array of collapsible polygonal tubes is disposed between a first member and a second member of a battery enclosure. The array of collapsible polygonal tubes is configured to deform to absorb impact energy. The array of collapsible polygonal tubes is integrally formed with at least one of the first member and the second member.

### BRIEF DESCRIPTION OF THE DRAWINGS

FIG. 1 depicts a diagram of an example electric vehicle, in accordance with embodiments of the present disclosure.

FIG. 2 depicts a front perspective view of an example battery enclosure for an electric vehicle, in accordance with embodiments of the present disclosure.

FIG. 3 depicts a bottom view of an example battery enclosure with an example energy absorbing component, in accordance with embodiments of the present disclosure.

FIG. 4A depicts a transverse sectional view of an example battery enclosure with an example energy absorbing component, in accordance with embodiments of the present disclosure.

FIG. 4B depicts a portion of the transverse sectional view depicted in FIG. 4A, in accordance with embodiments of the present disclosure.

FIG. 4C depicts a portion of the transverse sectional view depicted in FIG. 4B, in accordance with embodiments of the present disclosure.

FIG. 4D depicts a portion of the transverse sectional view depicted in FIG. 4C, in accordance with embodiments of the present disclosure.

FIGS. 5A, 5B, 5C depict transverse sectional views of example energy absorbing components, in accordance with embodiments of the present disclosure.

### DETAILED DESCRIPTION

A battery enclosure for an electric vehicle provides a sealed housing to protect the battery pack from exposure to water, dust, debris and other elements. In one example, the battery enclosure may include, inter alia, a battery pack, a bottom tray that supports the battery pack, a frame attached to the bottom tray, and a top cover (or tub) attached to the frame (and/or the bottom tray). In another example, the battery enclosure may include a battery pack, a bottom tub that supports the battery pack, a frame attached to the bottom tub, and a top cover (or tray) attached to the frame (and/or the bottom tub).

The top cover may be sealed to the bottom tray (or tub), and the frame may include one or more longitudinal members that are located within the enclosed space formed by the top cover and the bottom tray or tub. Alternatively, the frame may include transverse and longitudinal members that form a rectangular outer frame, the top cover may be sealed to the upper surface of the frame, and the bottom tray or tub may be sealed to the lower surface of the frame. Additionally, one or more cooling plates may be attached to, or integrally formed with, the bottom tray (or tub) and/or the top cover. Alternatively, one or more cooling plates may be attached to the sides of the battery pack, located within the battery pack, etc.

Other configurations of the battery enclosure are also possible.

A battery enclosure for an electric vehicle has strict structural and sealing requirements. The structural requirements may include, inter alia, a satisfactory reaction to an impact load, such as an underside impact (i.e., an impact to the underside of the vehicle), a side pole impact, a frontal offset impact, etc. The sealing requirements may include, inter alia, protection against water ingress, remaining sealed through 5 minutes of thermal runaway, etc.

Battery enclosures typically implement lightweight, metallic panels or sheets for many components, including the bottom tray (or tub) and the top cover of the battery enclosure. However, such panels can be damaged by various types of impact loads. For example, an impact load caused by road debris (such as rocks, pieces of asphalt, pieces of metal, tree branches, etc.) may damage a bottom portion of the metallic panel underneath the battery pack. Additionally, the road debris may penetrate through the metallic panel possibly leading to further damage.

Embodiments of the present disclosure advantageously provide an energy absorbing component for a battery enclosure that includes a collapsible structure disposed between a first member and a second member. The collapsible structure is configured to absorb impact energy. In some embodiments, the collapsible structure can be integrally formed with the first member and/or the second member (such as by an aluminum extrusion process, etc.).

In certain embodiments, the collapsible structure may include collapsible ribs. Each collapsible rib includes at least a first portion joined to the first member, and a second portion joined to the second member. The first portion of each collapsible rib has a different thickness than the second portion of each collapsible rib (such as 1.8 mm vs. 1.6 mm, etc.). A first surface of the first portion forms an acute angle with respect to the first member, such as 30°, 45°, 60°, 75°, etc. A second surface of the first portion (opposite to the first surface) forms an obtuse angle with respect to the first member, such as 120°, 135°, 150°, 165°, etc. Similarly, a first surface of the second portion forms an acute angle with respect to the second member, such as 30°, 45°, 60°, 75°, etc. A second surface of the second portion (opposite to the first surface) forms an obtuse angle with respect to the second member, such as 120°, 135°, 150°, 165°, etc.

Advantageously, due to the variable thickness and angular cross-section of the collapsible ribs, at least a portion of the collapsible ribs will deform to absorb at least a portion of the impact energy. Absorbing at least a portion of the impact energy may prevent a breach of the sealed battery enclosure, and may prevent or reduce damage to the cold plate and battery pack.

In certain other embodiments, the energy absorbing collapsible structure may include an array of collapsible polygonal tubes (such as hexagonal tubes, etc.) that may be integrally formed with the first member and/or the second member. Advantageously, due to the angular cross-section of the polygonal tubes, at least a portion of the array of collapsible polygonal tubes will deform to absorb at least a portion of the impact energy.

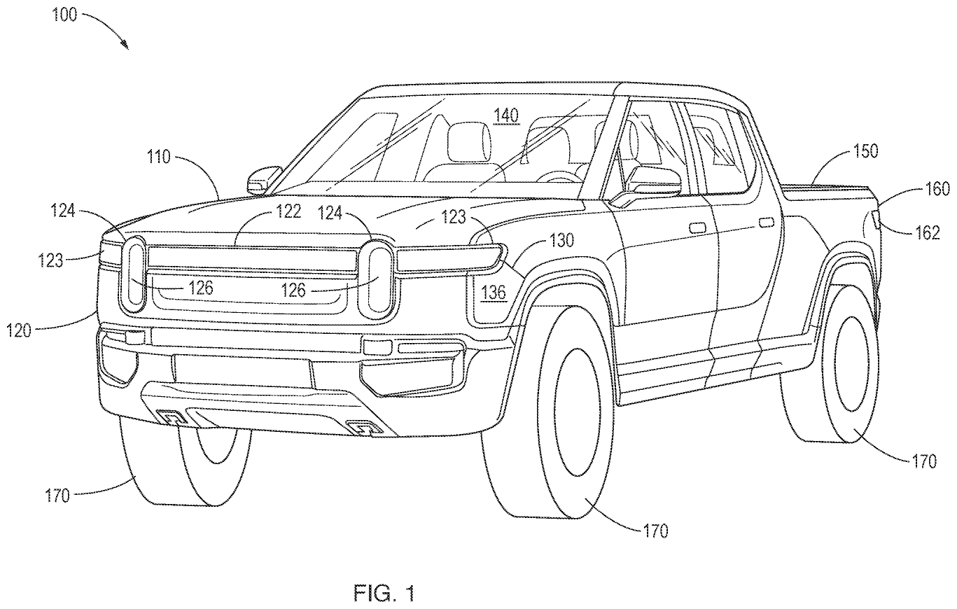

FIG. 1 depicts a diagram of electric vehicle 100, in accordance with embodiments of the present disclosure.

Electric vehicle 100 includes, inter alia, a frame and body 110, an electrical power storage and distribution system, a propulsion system, a suspension system, a steering system, auxiliary and accessory systems (such as thermal management, lighting, wireless communications, navigation, etc.), etc.

Generally, body 110 may be directly or indirectly mounted to a frame (i.e., body-on-frame construction), or body 110 may be formed integrally with a frame (i.e., unibody construction). Body 110 includes, inter alia, front end 120, front light bar 122, front turn lights 123, stadium light ring 124, headlights 126, charging port 130 with charging port cover 136 concealing charging connector socket, driver/passenger compartment or cabin 140, bed 150, rear end 160 with rear tail lights 162, a rear light bar, etc. Electric vehicle 100 may be a pickup truck, a sport utility vehicle (SUV) in which bed 150 is replaced by an extension of cabin 140, or a sedan in which bed 150 is replaced by a trunk. In certain embodiments, electric vehicle may be an electric delivery vehicle, an electric cargo van, etc.

The propulsion system may include, inter alia, one or more ECUs, one or more EDUs, wheels 170, etc. The electrical power storage and distribution system may include, inter alia, one or more ECUs, a battery pack including one or more battery modules, a vehicle charging subsystem including charging port 130, high voltage (HV) cables, etc.

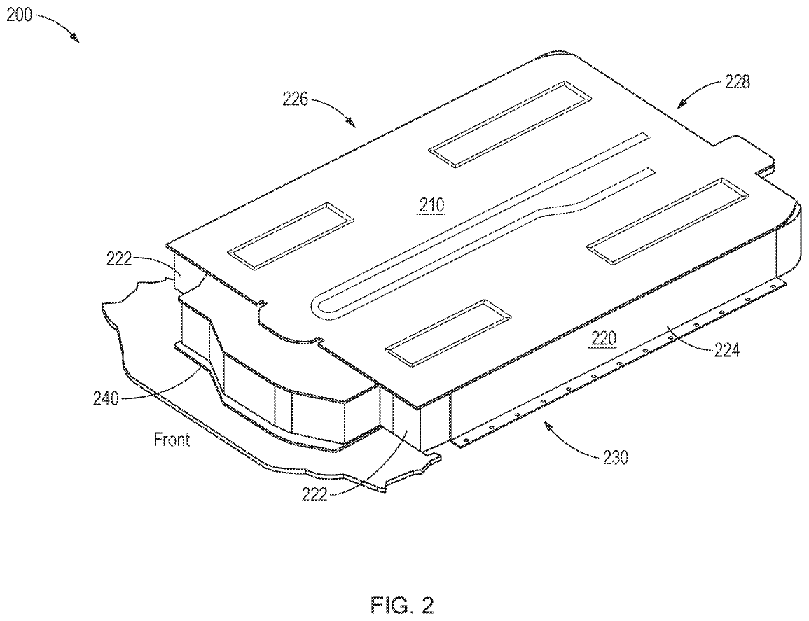

FIG. 2 depicts a front perspective view of battery enclosure 200 for an electric vehicle, in accordance with embodiments of the present disclosure.

Battery enclosure 200 includes, inter alia, top cover 210, frame 220, bottom tub 230, power electronics enclosure 240, and a battery pack (not shown in FIG. 2). Frame 220 includes front member 222, side member 224, side member 226, and rear member 228 that form a rectangular outer frame. Top cover 210 is a tray that is sealed to the upper surfaces of front member 222, side member 224, side member 226, and rear member 228. Bottom tub 230 is sealed to the lower surfaces of front member 222, side member 224, side member 226, and rear member 228. Power electronics enclosure 240 is attached to front member 222, and contains high voltage power distribution components for the battery pack.

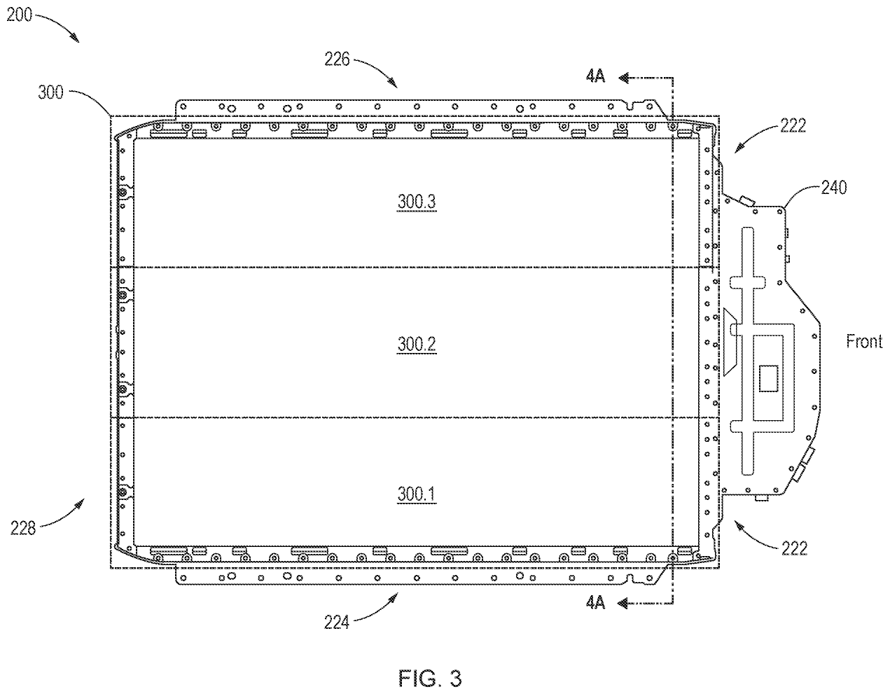

FIG. 3 depicts a bottom view of battery enclosure 200 with energy absorbing component 300, in accordance with embodiments of the present disclosure.

Generally, energy absorbing component 300 is attached to front member 222, rear member 228, side member 224, side member 226, and bottom tub 230 using fasteners, such as screws, bolts, rivets, etc. Because energy absorbing component 300 covers the entirety of the lower surface of bottom tub 230, energy absorbing component 300 protects battery enclosure 200 from underside impacts caused by road debris (such as rocks, stones, pieces of asphalt, pieces of metal, tree branches, etc.). In other embodiments, energy absorbing component 300 may cover a portion of the lower surface of bottom tub 230, such as 90%, 80%, etc.

In certain embodiments, energy absorbing component 300 may include a number of smaller energy absorbing components 300.i, such as energy absorbing components 300.1, 300.2, 300.3. Energy absorbing component 300.1 is attached to a portion of front member 222, side member 224, a portion of rear member 228, and a portion of bottom tub 230. Energy absorbing component 300.2 is attached to a portion of front member 222, a portion of rear member 228, and a portion of bottom tub 230. Energy absorbing component 300.3 is attached to a portion of front member 222, side member 226, a portion of rear member 228, and a portion of bottom tub 230. In other embodiments, two energy absorbing components 300.i may be used to cover the lower surface of bottom tub 230, four energy absorbing components 300.i may be used to cover the lower surface of bottom tub 230, etc.

When additional protection is desired (such as from side impacts, etc.), energy absorbing components 300 may be attached to front member 222, side member 224, side member 226, and/or rear member 228. These energy absorbing components 300 may cover the entirety of the frame members, a portion of the frame members, etc. One or more energy absorbing components 300 may also protect top cover 210, if desired.

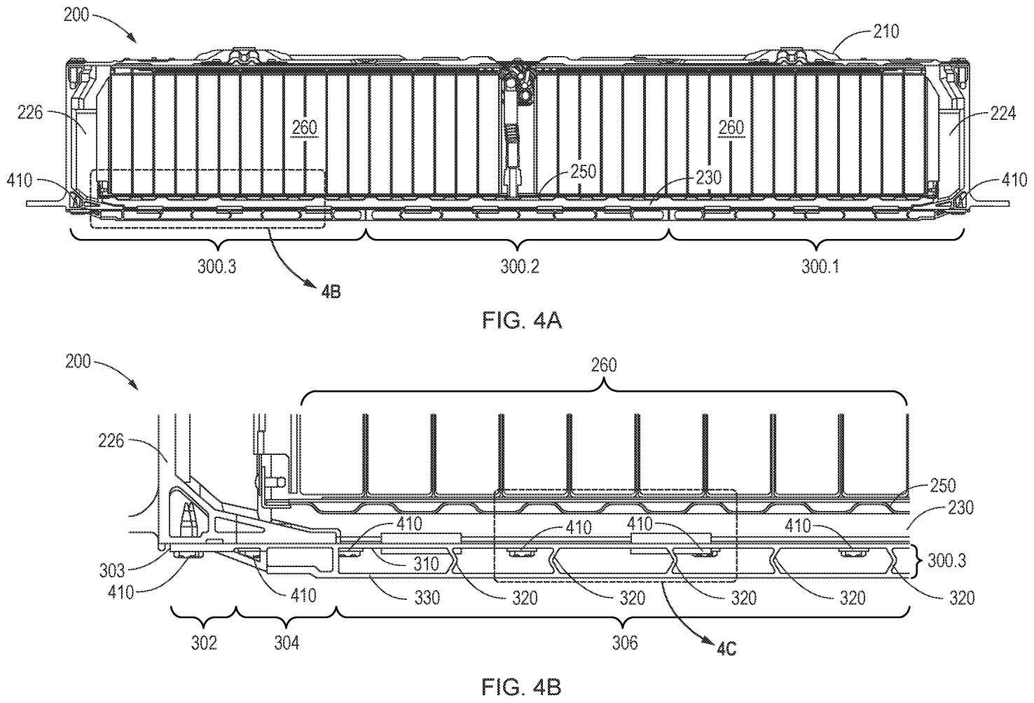

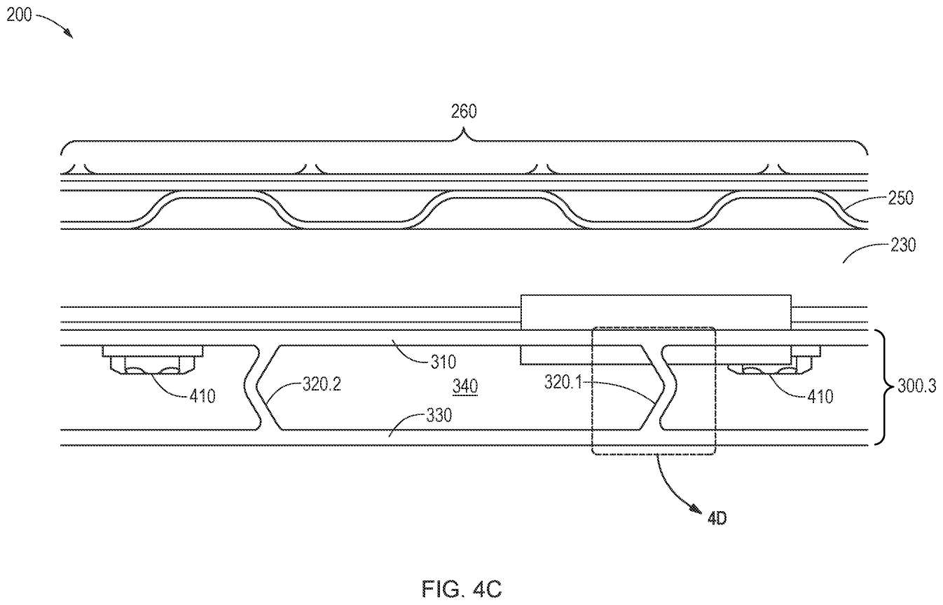

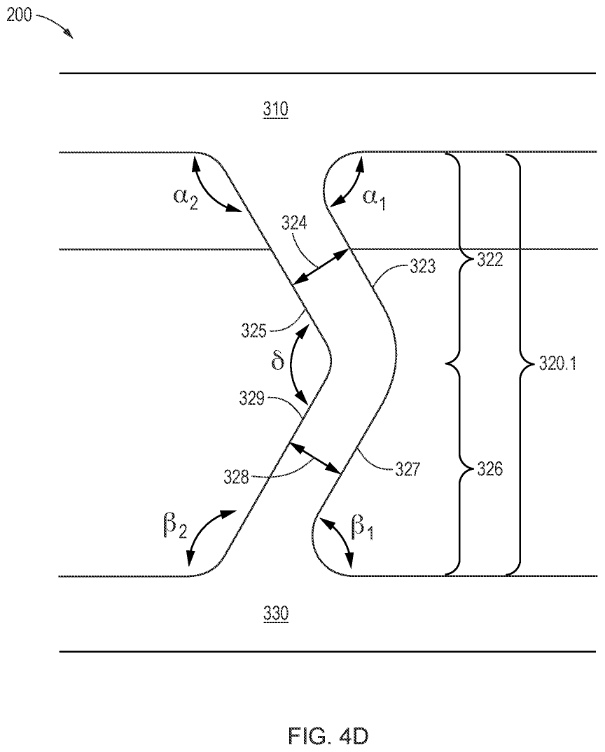

FIG. 4A depicts a transverse sectional view of battery enclosure 200 with energy absorbing components 300.1, 300.2, 300.3, in accordance with embodiments of the present disclosure.

Top cover 210, side member 224, side member 226, bottom tub 230, cooling plate 250, battery pack 260, and energy absorbing components 300.1, 300.2, 300.3 are depicted.

Cooling plate 250 includes multiple flow channels that are coupled to a cooling manifold that circulates cooling fluid through cooling plate 250. Battery pack 260 includes multiple battery cells, such as prismatic cells, cylindrical cells, pouch cells, etc.; in certain embodiments, battery pack 260 may be organized into a number of battery modules.

As depicted in FIG. 4A, energy absorbing component 300.1 is attached to side member 224 using fastener 410, and energy absorbing component 300.3 is attached to side member 226 using fastener 410. Fasteners are also used to attach energy absorbing components 300.1, 300.2, 300.3 to bottom tub 230 (as depicted in FIGS. 4B, 4C for energy absorbing component 300.3).

FIG. 4B depicts a portion of the transverse sectional view depicted in FIG. 4A, in accordance with embodiments of the present disclosure.

Side member 226, bottom tub 230, cooling plate 250, battery pack 260, energy absorbing component 300.3, and fasteners 410 are depicted.

Generally, energy absorbing component 300.3 includes outer section 302, transition section 304, and collapsible section 306. Similarly, energy absorbing component 300.1 includes an outer section that is attached to side member 224, a transition section, and a collapsible section. Energy absorbing component 300.2 includes a collapsible section that is attached to the collapsible sections of energy absorbing components 300.1, 300.3.

Outer section 302 includes flange 303 that receives fasteners 410 to attach energy absorbing component 300.3 to side member 226 (as well as front member 222 and rear member 228). Transition section 304 joins relatively flat outer section 302 to collapsible section 306, and also receives fasteners 410 to attach energy absorbing component 300.3 to bottom tub 230. Collapsible section 306 receives fasteners 410 to attach energy absorbing component 300.3 to bottom tub 230.

Collapsible section 306 includes first member 310, collapsible ribs 320, and second member 330. First member 310 may be a generally flat surface that receives fasteners 410 to attach energy absorbing component 300.3 to bottom tub 230 of battery enclosure 200. Collapsible ribs 320 are disposed between first member 310 and second member 330, and are configured to deform to absorb impact energy (as discussed below).

In the configuration depicted in FIGS. 4A to 4D, first member 310 is an upper plate (e.g., positioned between the battery pack 260 and the second member 330), and second member 330 is a lower plate (e.g., positioned between the first member 310 and an environment external to the battery enclosure 200, such as between the first member 310 and a surface on which the vehicle is driving). When energy absorbing component 300.3 is attached to top cover 210, energy absorbing component 300.3 is rotated 180° so that first member 310 is a lower plate, and second member 330 is an upper plate. When energy absorbing component 300.3 is attached to front member 222, side member 224, side member 226, and/or rear member 228, energy absorbing component 300.3 is rotated 90° so that first member 310 is an inner plate, and second member 330 is an outer plate.

In certain embodiments, collapsible ribs 320 may be integrally formed with first member 310 and/or second member 330, such as by an aluminum extrusion process. For example, the first member, second member and collapsible ribs may be extruded in various ways. In one example, the collapsible ribs and the first member may be extruded as a single piece and then attached to the second member. In another example, the collapsible ribs and the second member may be extruded as a single piece and then attaches to the first member. In a further example, the collapsible ribs, the first member, and the second member may be extruded as a single piece. The extruded pieces may be attached together by welding, brazing, soldering, adhesive, etc.

FIG. 4C depicts a portion of the transverse sectional view depicted in FIG. 4B, in accordance with embodiments of the present disclosure.

Bottom tub 230, cooling plate 250, battery pack 260, energy absorbing component 300.3, and fasteners 410 are depicted.

In certain embodiments, collapsible ribs 320 may include collapsible ribs 320.1 and collapsible ribs 320.2. Collapsible ribs 320.1 have an angular cross-section with a first orientation (such as a chevron shape pointing in a first direction), while collapsible ribs 320.2 have an angular cross-section with a second orientation that is opposite to the first orientation (such as a chevron shape pointing in a second direction).

As depicted in FIGS. 4A, 4B, 4C, each pair of adjacent collapsible ribs 320 have different orientations. In other words, each pair of adjacent collapsible ribs 320 includes one collapsible rib 320.1 and one collapsible rib 320.2. In certain other embodiments, collapsible ribs 320 may include collapsible ribs 320.1 (only), and each pair of adjacent collapsible ribs 320.1 have the same orientation. Similarly, collapsible ribs 320 may include collapsible ribs 320.2 (only), and each pair of adjacent collapsible ribs 320.2 have the same orientation.

For example, each adjacent pair of collapsible ribs may include a first collapsible rib and a second collapsible rib. The first collapsible rib has a chevron shape pointing in the first direction (such as to the right) and the second collapsible rib has a chevron shape pointing in the first direction. Or, the first collapsible rib has a chevron shape pointing in the first direction and the second collapsible rib has a chevron shape pointing in the second direction (such as to the left). Or, the first collapsible rib has a chevron shape pointing in the second direction and the second collapsible rib has a chevron shape pointing in the first direction. Or, the first collapsible rib has a chevron shape pointing in the second direction and the second collapsible rib has a chevron shape pointing in the second direction.

Other combinations of collapsible ribs 320.1, 320.2 are also contemplated, such as a repeating sequence of collapsible ribs 320.1, 320.2 that includes more than two pairs of collapsible ribs 320 in the sequence.

Generally, each pair of adjacent collapsible ribs 320, a portion of first member 310, and a portion of second member 330 define channel 340. In certain embodiments, metal foam or crushable plastic may be disposed in each channel 340.

FIG. 4D depicts a portion of the transverse sectional view depicted in FIG. 4C, in accordance with embodiments of the present disclosure.

First member 310, collapsible rib 320.1, and second member 330 are depicted. The following discussion also applies to collapsible rib 320.2, which is a mirror image of collapsible rib 320.1. Generally, collapsible rib 320.1 has a chevron shape that is pointed in the first direction (such as to the right, which is also known as a right chevron or a right-pointing chevron). Collapsible rib 320.2 has a chevron shape that is pointed in the second direction (such as to the left, which is also known as a left chevron or a left-pointing chevron).

Collapsible rib 320.1 includes first portion 322 joined to first member 310, and second portion 326 joined to second member 330. In certain embodiments, first portion 322 and second portion 326 merge at the center of collapsible rib 320.1, while in other embodiments, first portion 322 and second portion 326 may merge above or below the center of collapsible rib 320.1.

First portion 322 includes first surface 323, center thickness 324, and second surface 325. First surface 323 forms angle 1 with respect to first member 310 that is less than 90°. In certain embodiments, angle α₁ may be between 45° and 75°, such as 60°. Similarly, second surface 325 forms angle α₂ with respect to first member 310 that is greater than 90°. In certain embodiments, angle α₂ may be between 135° and 165°, such as 150°. In some embodiments, angle α₁ and angle α₁ may be supplementary angles.

Second portion 326 includes first surface 327, center thickness 328, and second surface 329. First surface 327 forms angle β₁ with respect to second member 330 that is less than 90°. In certain embodiments, angle β₁ may be between 45° and 75°, such as 60°. Similarly, second surface 329 forms angle β₂ with respect to second member 330 that is greater than 90°. In certain embodiments, angle β₂ may be between 135° and 165°, such as 150°. In some embodiments, angle β₁ and angle β₁ may be supplementary angles.

Second surface 325 and second surface 329 form angle δ with respect to one another.

Center thickness 324 and center thickness 328 may be different. In certain embodiments, center thickness 328 is less than center thickness 324, while in other embodiments, center thickness 328 is greater than center thickness 324. The difference in thickness may be about 10%, such as 1.6 mm and 1.8 mm, 1.5 mm and 2.0 mm. Other thickness differences are also supported, such as 5% 15%, 20%, 25%, 30%, 50%, etc.

Advantageously, collapsible rib 320.1 will deform to absorb a portion of the impact energy from an impact load due to the angles α₁, α₂, β₁, β₂, and δ of collapsible rib 320.1 and the difference in center thickness 324 and center thickness 329.

In certain other embodiments, center thickness 328 may be the same as center thickness 324, and collapsible rib 320.1 will deform to absorb a portion of the impact energy from an impact load due to the angles α₁, α₂, β₁, β₂, and δ of collapsible rib 320.1.

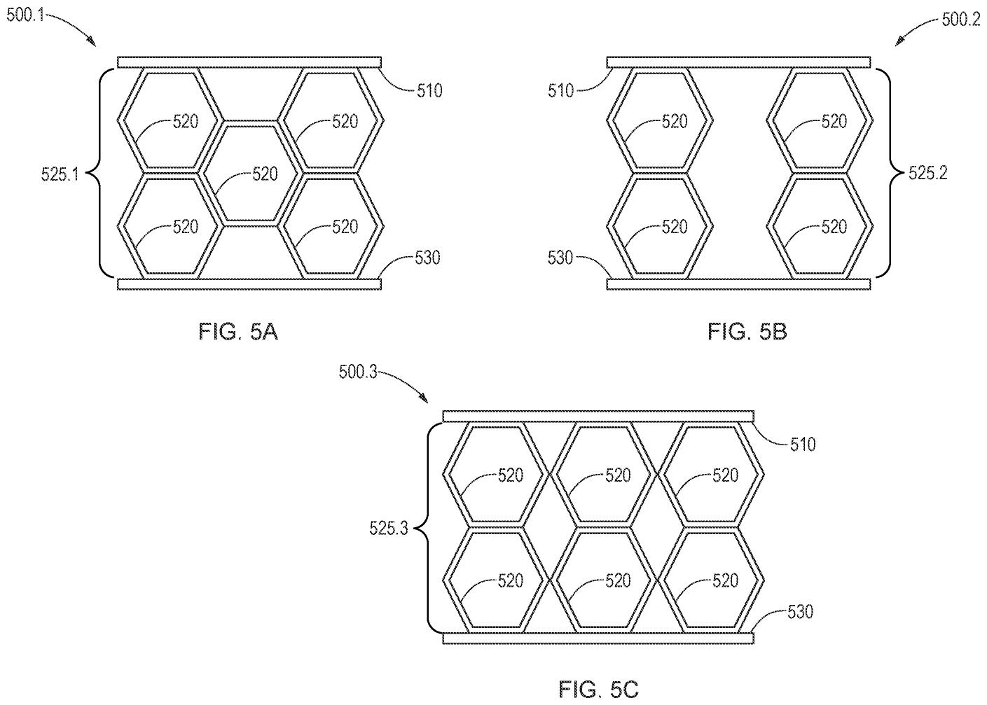

FIGS. 5A, 5B, 5C depict a transverse sectional view of energy absorbing components 500.1, 500.2, 500.3, respectively, in accordance with embodiments of the present disclosure.

In certain embodiments, energy absorbing component 500.1 includes first member 510, array 525.1 of collapsible polygonal tubes 520, and second member 530. Generally, first member 510 is the same (and performs the same functions) as first member 310, and second member 530 is the same (and performs the same functions) as second member 330. Array 525.1 is configured to deform to absorb impact energy, and may be integrally formed with first member 510 and/or second member 530, such as by the aluminum extrusion process described above. In certain embodiments, at least a portion of array 525.1 of collapsible polygonal tubes 520 deforms to absorb at least a portion of the impact energy.

In certain embodiments, energy absorbing component 500.2 includes first member 510, array 525.2 of collapsible polygonal tubes 520, and second member 530. Generally, first member 510 is the same (and performs the same functions) as first member 310, and second member 530 is the same (and performs the same functions) as second member 330. Array 525.2 is configured to deform to absorb impact energy, and may be integrally formed with first member 510 and/or second member 530, such as by the aluminum extrusion process described above. In certain embodiments, at least a portion of array 525.2 of collapsible polygonal tubes 520 deforms to absorb at least a portion of the impact energy.

In certain embodiments, energy absorbing component 500.3 includes first member 510, array 525.3 of collapsible polygonal tubes 520, and second member 530. Generally, first member 510 is the same (and performs the same functions) as first member 310, and second member 530 is the same (and performs the same functions) as second member 330. Array 525.3 is configured to deform to absorb impact energy, and may be integrally formed with first member 510 and/or second member 530, such as by the aluminum extrusion process described above. In certain embodiments, at least a portion of array 525.3 of collapsible polygonal tubes 520 deforms to absorb at least a portion of the impact energy.

In certain embodiments, each collapsible polygonal tube 520 has a hexagonal cross-sectional shape. In other embodiments, each collapsible polygonal tube 520 may have a pentagonal cross-sectional shape, a heptagonal cross-sectional shape, etc.

In certain embodiments, metal foam or crushable plastic may be disposed in each polygonal tube 520.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. An energy absorbing component, comprising:
collapsible ribs disposed between a first member and a second member of a battery enclosure, the collapsible ribs configured to deform to absorb impact energy,
wherein each collapsible rib comprises:
a first portion joined to the first member, the first portion having a first thickness, and
a second portion joined to the second member, the second portion having a second thickness that is different than the first thickness.

2. The energy absorbing component of claim 1, wherein the second thickness is about 5% to about 50% less than the first thickness.

3. The energy absorbing component of claim 1, wherein:
the first portion has a first surface that forms a first angle with respect to the first member that is between 45° and 75°;
the first portion has a second surface that forms a second angle with respect to the first member that is between 135° and 165°;
the second portion has a first surface that forms a third angle with respect to the second member that is between 45° and 75°; and
the second portion has a second surface that forms a fourth angle with respect to the second member that is between 135° and 165°.

4. The energy absorbing component of claim 3, wherein:
the third angle is the same as the first angle; and
the fourth angle is the same as the second angle.

5. The energy absorbing component of claim 1, wherein each collapsible rib has a chevron shape pointing in a first direction or a second direction opposite to the first direction.

6. The energy absorbing component of claim 5, wherein each adjacent pair of collapsible ribs includes a first collapsible rib and a second collapsible rib, and wherein:
the first collapsible rib has a chevron shape pointing in the first direction and the second collapsible rib has a chevron shape pointing in the first direction;
the first collapsible rib has a chevron shape pointing in the first direction and the second collapsible rib has a chevron shape pointing in the second direction;
the first collapsible rib has a chevron shape pointing in the second direction and the second collapsible rib has a chevron shape pointing in the first direction; or
the first collapsible rib has a chevron shape pointing in the second direction and the second collapsible rib has a chevron shape pointing in the second direction.

7. The energy absorbing component of claim 1, wherein the first portion of each collapsible rib and the second portion of each collapsible rib meet at a center of each collapsible rib to define an angular cross-section of each collapsible rib.

8. The energy absorbing component of claim 7, wherein:
the angular cross-section of each collapsible rib has a first orientation or a second orientation that is opposite to the first orientation; and
the angular cross-sections of each pair of adjacent collapsible ribs have different orientations, or the angular cross-sections of each pair of adjacent collapsible ribs have a same orientation.

9. The energy absorbing component of claim 1, wherein each pair of adjacent collapsible ribs, a portion of the first member, and a portion of the second member define a channel.

10. The energy absorbing component of claim 9, wherein metal foam or crushable plastic is disposed in each channel.

11. The energy absorbing component of claim 1, wherein:
the first member is an upper plate and the second member is a lower plate;
the first member is the lower plate and the second member is the upper plate; or
the first member is an inner plate and the second member is an outer plate.

12. The energy absorbing component of claim 1, wherein:
the first member, the second member, and the collapsible ribs are formed by extrusion; and
the collapsible ribs are extruded with the first member and attached to the second member, the collapsible ribs are extruded with the second member and attached to the first member, or the first member, the second member, and the collapsible ribs are extruded together.

13. An energy absorbing component, comprising:
an array of collapsible polygonal tubes disposed between a first member and a second member of a battery enclosure, the array of collapsible polygonal tubes configured to deform to absorb impact energy,
wherein the array of collapsible polygonal tubes is integrally formed with at least one of the first member and the second member.

14. The energy absorbing component of claim 13, wherein each collapsible polygonal tube has a hexagonal cross-sectional shape.

15. The energy absorbing component of claim 13, wherein at least a portion of the array of collapsible polygonal tubes deforms to absorb at least a portion of the impact energy.

16. The energy absorbing component of claim 13, wherein:
the first member is an upper plate and the second member is a lower plate;
the first member is the lower plate and the second member is the upper plate; or
the first member is an inner plate and the second member is an outer plate.

17. The energy absorbing component of claim 13, wherein:
the first member is formed by extrusion;
the second member is formed by extrusion;
the collapsible polygonal tubes are formed by extrusion; and
the collapsible polygonal tubes are extruded with the first member and attached to the second member, the collapsible polygonal tubes are extruded with the second member and attached to the first member, or the first member, the second member and the collapsible polygonal tubes are extruded together.

18. The energy absorbing component of claim 13, wherein metal foam or crushable plastic is disposed in each collapsible polygonal tube.

19. A method, comprising:
providing an energy absorbing component for a battery pack, the energy absorbing component including:
collapsible ribs disposed between a first member and a second member of a battery enclosure, the collapsible ribs configured to deform to absorb impact energy, wherein each collapsible rib comprises:
a first portion joined to the first member, the first portion having a first thickness, and
a second portion joined to the second member, the second portion having a second thickness that is different than the first thickness.

20. The method of claim 19, wherein:
the second thickness is about 5% to about 50% less than the first thickness;
the first portion of each collapsible rib and the second portion of each collapsible rib meet at a center of each collapsible rib to define an angular cross-section of each collapsible rib; and
each pair of adjacent collapsible ribs, a portion of the first member, and a portion of the second member define a channel.
